(19) United States
(12) Patent Application Publication
(10) Pub. No.: US 2011/0090578 A1
(43) Pub. Date: Apr. 21, 2011

(54) LENS SHIFTER AND PROJECTOR USING THE SAME

(75) Inventor: Taichi Yoshimura, Osaka-shi (JP)

(73) Assignee: SANYO ELECTRIC CO., LTD., Osaka (JP)

(21) Appl. No.: 12/904,473

(22) Filed: Oct. 14, 2010

(30) Foreign Application Priority Data
Oct. 16, 2009 (JP) 2009-239273

(51) Int. Cl. G02B 7/02

(52) U.S. Cl. 359/811

(57) ABSTRACT

A lens shifter includes a fixed base and a movable base, which is movable relative to the fixed member and receives a projection lens. A drive mechanism applies driving force to the movable base. The drive mechanism includes a driver that generates force. A gear train transmits the force generated by the driver. A rack converts the force transmitted from the gear train into driving force for the movable base. The rack includes a tooth face extending along a tooth trace direction. A contact surface is formed only on part of the tooth face and receives the force from the gear train.

### CROSS-REFERENCE TO RELATED APPLICATIONS

This application is based upon and claims the benefit of priority from prior Japanese Patent Application No. 2009-239273, filed on Oct. 16, 2009, the entire contents of which are incorporated herein by reference.

### BACKGROUND OF THE INVENTION

The present invention relates to a lens shifter for an optical mechanism that shifts the position of a lens in a horizontal direction and/or vertical direction.

A projector generally projects images onto a screen. Such a projector must project an image onto a screen at a predetermined position. Thus, a lens shifter is used to shift the position of a projection lens in a horizontal direction and/or a vertical direction to adjust the horizontal position and/or vertical position of the projected image.

Japanese Laid-Open Patent Publication No. 2006-285260 describes such a lens shifter for a projector. The lens shifter of the publication will now be described with reference to FIGS. 1 to 3. In the description hereafter, the “horizontal direction” and the “vertical direction” respectively refer to the horizontal direction and the vertical direction of the lens shifter when viewing the lens shifter from the front (from a position facing toward the projection lens).

The lens shifter includes a fixed base 1, which is fixed to a main body chassis, a movable base 2, to which a projection lens is attached, and a drive mechanism 4, which moves the movable base 2. The movable base 2 is movable relative to the fixed base 1 in the horizontal and vertical directions.

The fixed base 1 is directly fastened to the main body chassis by screws at a front side of the main body. Further, the movable base 2 includes a horizontal movable base member 20, which is movable relative to the fixed base 1 in the horizontal direction, and a vertical movable base member 30, which is movable relative to the horizontal movable base member 20 in the vertical direction.

Referring to FIG. 2, the horizontal movable base member 20 has a rear surface including three projections 21. Each projection 21 is inserted through a horizontally elongated hole 11, which extends through the fixed base 1, and projects out of the rear side of the fixed base 1. A washer 22, which has a diameter that is greater than the width of the horizontally elongated hole 11, is fitted onto the projection 21. A coil spring is further fitted onto each projection 21 in a compressed state. As a result, the urging force of the coil springs presses the horizontal movable base member 20 against the fixed base 1 as the horizontal movable base member 20 moves in the horizontal direction relative to the fixed base 1.

Referring to FIG. 3, the vertical movable base member 30 has a rear surface including three bosses 31, each having a threaded hole. Each boss 31 is inserted into a corresponding vertical elongated hole 23, which extends through the horizontal movable base member 20, toward the rear of the horizontal movable base member 20. A plate spring 32 is fastened by a screw to each boss 31. The plate spring 32 is wider than the boss 31. As a result, the urging force of the plate springs 32 presses the vertical movable base member 30 against the horizontal movable base member 20 as the vertical movable base member 30 moves relative to the horizontal movable base member 20 in the vertical direction while being guided by the vertical elongated holes 23. When the horizontal movable base member 20 moves in the horizontal direction relative to the fixed base 1, the vertical movable base member 30 moves in the horizontal direction together with the horizontal movable base member 20 Accordingly, the vertical movable base member 30 indirectly moves in the vertical direction and the horizontal direction relative to the fixed base 1. The projection lens is fixed to such a vertical movable base member 30. Thus, the projection lens is movable in the vertical direction and the horizontal direction.

Referring to FIG. 1, the drive mechanism 4 includes a horizontal drive mechanism unit 40, which drives the horizontal movable base member 20 in the horizontal direction, and a vertical drive mechanism unit 50, which drives the vertical movable base member 30 in the vertical direction.

The horizontal drive mechanism unit 40 includes a driver 41, which generates force for driving the horizontal movable base member 20, a gear train 42, which transmits the force generated by the driver 41, and a rack 43, which receives force from the driver 41 via the gear train 42.

In this related art example, a dial is used as the driver 41 to manually shift the projection lens. The driver 41 and the gear train 42 are coupled to a drive mechanism chassis 13. The rack 43, which receives force from the driver 41, is formed integrally with the right end of the horizontal movable base member 20.

The gear train 42 includes a rotor 42a, a worm 42b, a worm gear 42c, and a transmission shaft 42d. The rotor 42a is engaged by frictional force to the dial of the driver 41. The worm 42b is formed integrally with the rotor 42a. The worm gear 42c meshes with the worm 42b. The transmission shaft 42d is formed integrally with the worm gear 42c. The transmission shaft 42d is rotatable about its axis in forward and rearward directions (direction facing toward the projection lens). A pinion 42e is formed on one end of the transmission shaft 42d. The pinion 42e meshes with the rack 43. In the gear train 42, when the rotor 42a is in a rotatable state, rotation of the dial, which serves as the driver 41, causes frictional force and produces torque that is transmitted to the rotor 42a. The torque received by the rotor 42a is consequently transmitted from the pinion 42e to the rack 43 as a horizontal driving force that moves the horizontal movable base member 20 in the horizontal direction.

In the same manner as the horizontal drive mechanism unit 40, the vertical drive mechanism unit 50 includes a driver 51, which generates force for driving the vertical movable base member 30, a gear train 52, which transmits the force generated by the driver 51, and a rack 53, which receives force from the driver 51 via the gear train 52.

Like the driver 41, a dial is used as the driver 51 to manually shift the projection lens. The driver 51 and the gear train 52 are coupled to a drive mechanism chassis 14. The rack 53, which receives force from the driver 41, is formed integrally with the right end of the vertical movable base member 30, as viewed in the drawing.

The gear train 52 includes a rotor 52a, a bevel gear 52b, a bevel gear 52c, and a transmission shaft 52d. The rotor 52a is engaged by frictional force to the dial of the driver 51. The bevel gear 52b is fixed to the rotor 52a and has a horizontal axis. The bevel gear 52c meshes with the bevel gear 52b and has a horizontal axis. The transmission shaft 52d is formed integrally with the bevel gear 52c. The transmission shaft 52d is rotatable about its axis in forward and rearward directions (direction facing toward the projection lens). A worm 52e is formed on one end of the transmission shaft 52d. The worm 52e meshes with a worm gear 52f. A pinion 52g, which is formed integrally with the worm gear 52f, meshes with the rack 53. In the gear train 52, when the rotor 52a is in a rotatable state, rotation of the dial, which serves as the driver 51, causes frictional force to produce torque that is transmitted to the rotor 52a. The torque received by the rotor 52a is consequently transmitted from the pinion 52g to the rack 53. This moves the vertical movable base member 30, which is formed integrally with the rack 53, in the vertical direction.

As described above, in the lens shifter of the related art, when moving the horizontal movable base member 20 in the horizontal direction with the horizontal drive mechanism unit 40, the vertical movable base member 30 moves integrally with the horizontal movable base member 20 in the horizontal direction. In this state, the vertical movable base member 30 moves in the horizontal direction while the rack 53 is held in a state meshed with the pinion 52g of the gear train 52. To allow such a movement, the pinion 52g has a length set in correspondence with the horizontal movement range of the vertical movable base member 30 (i.e., the horizontal movable range of the horizontal movable base member 20).

In this manner, the lens shifter of the related art includes the racks 43 and 53, which mesh with the pinions 42e and 52g to move the horizontal movable base member 20 and the vertical movable base member 30. Further, the rack 43 is formed integrally with the horizontal movable base member 20, and the rack 53 is formed integrally with the vertical movable base member 30.

When the projector is dropped, for example, the weight of the projection lens may apply an impact to the racks 43 and 53. To resist such an impact, the racks 43 and 53 must be designed to be provided with high strength in correspondence with the weight of the projection lens. Accordingly, when the lens is heavy, the teeth of the racks 43 and 53 are normally formed with a larger face width to increase the strength. However, a larger face width increases slide resistance, which is produced at contact surfaces of the teeth. This increases the driving force and hinders smooth movement. In particular, with the related art example, when the horizontal movable base member 20 moves in the horizontal direction, the rack 53 moves along the pinion 52g, which transmits driving force in the vertical direction, while being held in a state meshed with the pinion 52g. This increases the sliding resistance of the rack 53.

### SUMMARY OF THE INVENTION

The present invention relates to a lens shifter that lowers the sliding resistance produced at a rack, which transmits driving force in a horizontal direction or a vertical direction, while increasing the strength of the rack.

One aspect of the present invention is a lens shifter for a projection lens. The lens shifter includes a fixed base. A movable base is movable relative to the fixed member. The projection lens is mounted to the movable base. A drive mechanism applies force to the movable base. The drive mechanism includes a driver that generates force. A gear train transmits the force generated by the driver. A rack converts the force transmitted from the gear train into driving force for the movable base. The rack includes a tooth face extending along a tooth trace direction. A contact surface is formed only on part of the tooth face and receives the force transmitted from the gear train.

A further aspect of the present invention is a projector includes a projection lens and a lens shifter. The lens shifter includes a fixed base and a movable base. The movable base is movable relative to the fixed member. The projection lens is mounted to the movable base. A drive mechanism applies force to the movable base. The drive mechanism includes a driver that generates force. A gear train transmits the force generated by the driver. A rack converts the force transmitted from the gear train into driving force for the movable base. The rack includes a tooth face extending along a tooth trace direction. A contact surface is formed only on part of the tooth face and receives the force transmitted from the gear train.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing the front structure of a lens shifter in the related art;

FIG. 2 is a front view showing a state in which a vertical movable base member is removed from the level shifter of FIG. 1;

FIG. 3 is a front view showing the lens shifter of FIG. 1;

FIG. 4 is a schematic perspective view showing a lens shifter according to a first embodiment of the present invention;

FIG. 5A is a schematic plan view showing a rack coupled to the lens shifter of FIG. 4;

FIG. 5B is a schematic plan view showing the rack of FIG. 5A;

FIG. 6A is a plan view showing a tooth in the rack of FIG. 5A;

FIG. 6B is a front view showing the tooth of FIG. 6A;

FIG. 6C is a cross-sectional view taken along line 6C-6C in FIG. 6A;

FIG. 7 is a schematic perspective view showing a lens shifter according to a second embodiment of the present invention;

FIG. 8 is an exploded perspective view showing a state in which a fixed base and a vertical movable base member are removed from the lens shifter of FIG. 7; and

FIG. 9 is an exploded perspective view showing a state in which a horizontal movable base member, a vertical drive mechanism, and a driver and gear train of a horizontal drive mechanism are removed from a main body chassis of the lens shifter shown in FIG. 8.

### DETAILED DESCRIPTION OF THE INVENTION

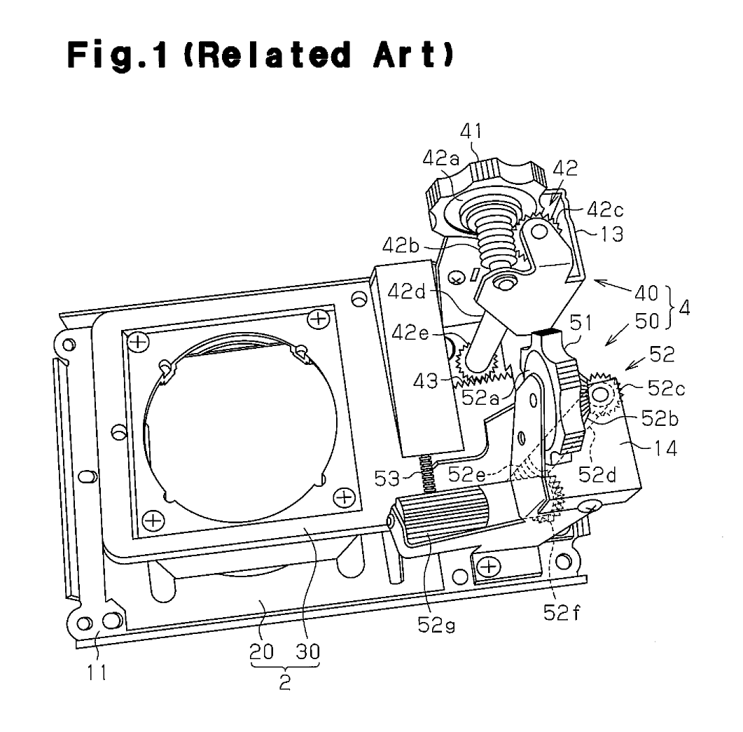

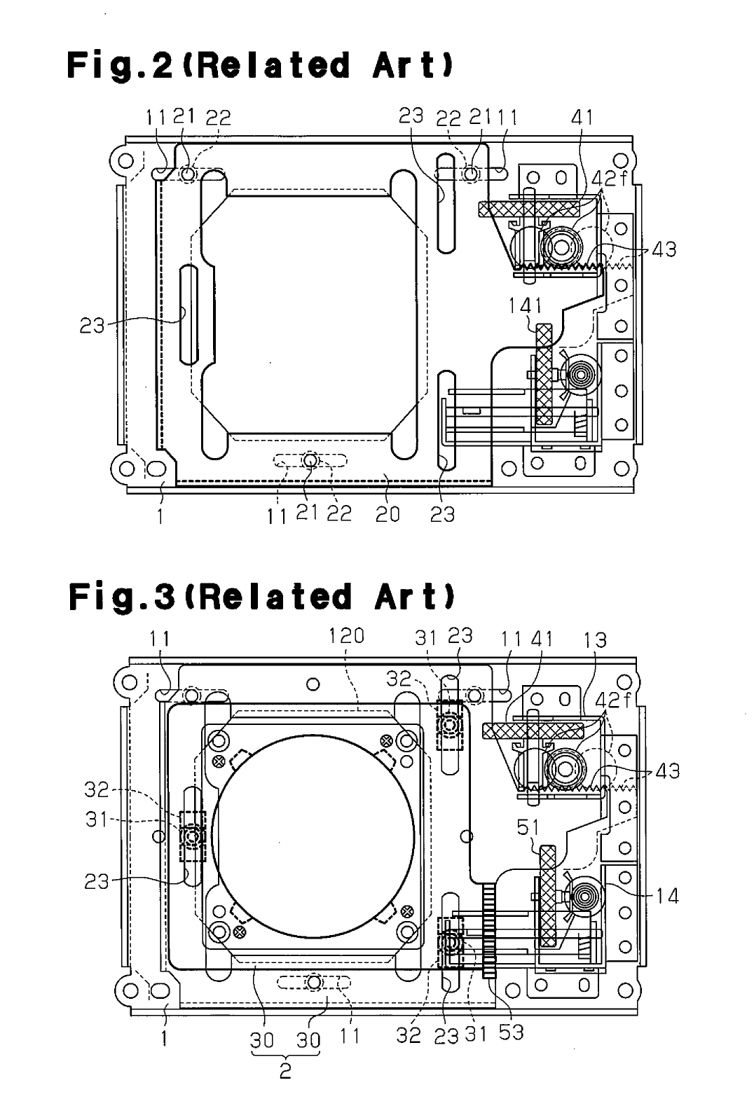

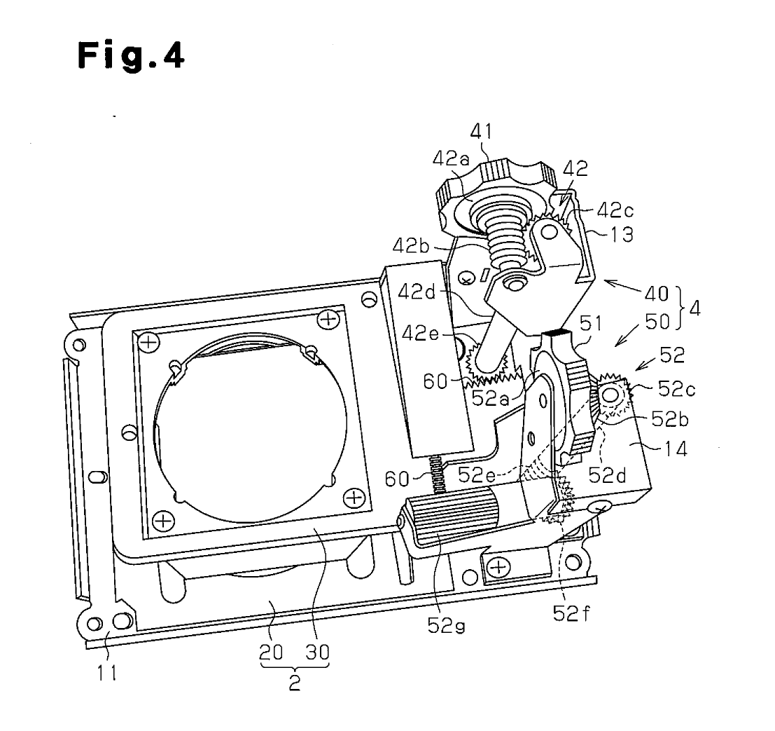

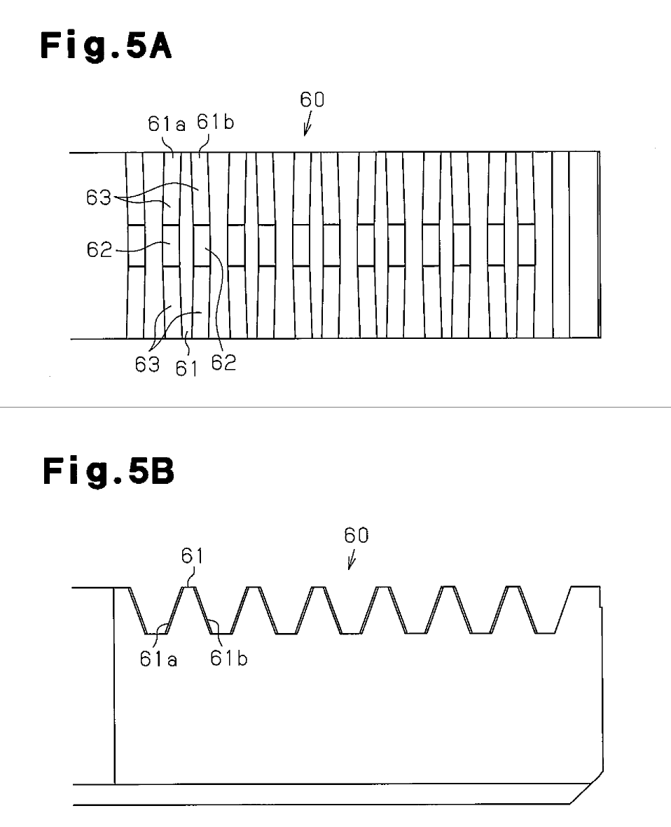

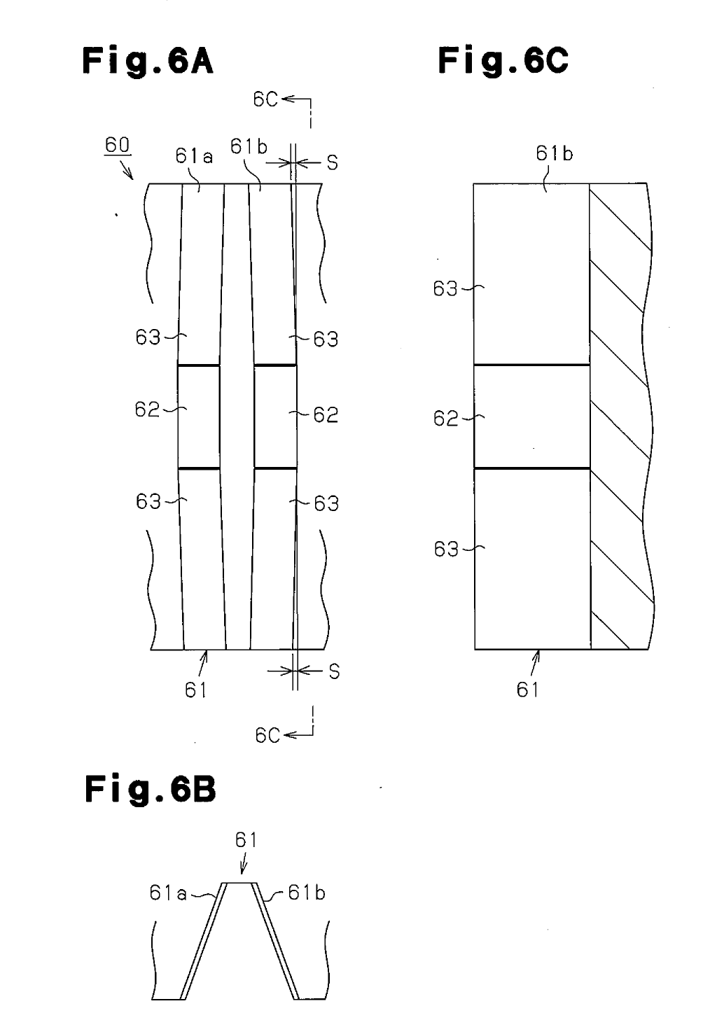

A lens shifter according to a first embodiment of the present invention will now be discussed with reference to FIGS. 4 to 6. The lens shifter is applied to, for example, a three-chip type LCD projector. The lens shifter of the first embodiment differs from the lens shifter of the related art shown in FIGS. 1 to 3 only in that the racks 43 and 53 are replaced by racks 60, which are shown in FIGS. 5 and 6. Otherwise, the lens shifter of the related art has the same structure as that shown in FIGS. 1 to 3.

Referring to FIG. 4, in the first embodiment, the lens shifter includes a fixed base 1, a movable base 2, which is movable relative to the fixed base 1, and a drive mechanism 4, which applies a driving force to the movable base 2. The movable base 2 includes a horizontal movable base member 20, which is movable relative to the fixed base 1 in the horizontal direction, and the vertical movable base member 30, which is movable relative to the horizontal movable base member 20 in the vertical direction.

The drive mechanism 4 includes a horizontal drive mechanism unit 40, which drives the horizontal movable base member 20 in the horizontal direction, and a vertical drive mechanism unit 50, which drives the vertical movable base member 30 in the vertical direction. The horizontal drive mechanism unit 40 includes a driver 41, which generates force for driving the horizontal movable base member 20, a gear train 42, which transmits the force generated by the driver 41, and a first rack 60, which receives force from the driver 41 via the gear train 42. In the same manner as the structure shown in FIG. 1, the first rack 60 is formed integrally with the right end of the horizontal movable base member 20. The vertical drive mechanism unit 50 includes a driver 51, which generates force for driving the vertical movable base member 30, a gear train 52, which transmits the force generated by the driver 51, and a second rack 60, which receives force from the driver 51 via the gear train 52. Like the structure shown in FIG. 1, the second rack 60 is formed integrally with the lower end of the vertical movable base member 30.

When the gear train 42 transmits force from the driver 41 of the horizontal drive mechanism unit 40 to the first rack 60, the horizontal movable base member 20 moves in the horizontal direction. When the gear train 52 transmits force from the driver 51 of the vertical drive mechanism unit 50 to the second rack 60, the vertical movable base member 30 moves in the vertical direction.

The first and second racks 60 each include teeth having a large face width to increase the strength. As shown in FIGS. 5 and 6, the first and second racks 60 each include a plurality of teeth 61. Tooth faces 61a and 61b are formed on opposite sides of each tooth 61 along the direction of the tooth trace. Each tooth face 61a and 61b includes a central part in the tooth trace direction that forms a contact surface 62, which receives force from the corresponding one of the gear trains 42 and 52. Clearance portions 63 extend from opposite sides of the contact surface 62 along the tooth trace direction. In the first embodiment, the contact surfaces 62 and the clearance portions 63 reduce the sliding resistance of the corresponding rack 60. As shown in FIG. 6C, the clearance portions 63 have constant dimensions in the direction of the tooth depth. Further, as shown in FIG. 6A, each clearance portion 63 extends linearly from one end of the corresponding contact surface 62 along the tooth trace direction. As a result, the clearance portion 63 has a clearance dimension (i.e., clearance region) that gradually enlarges from the end of the contact surface 62. In other words, the clearance portion 63 is formed so that the tooth thickness gradually decreases from the contact surface 62. Accordingly, the clearance dimension reaches the maximum dimension S at the end of the clearance portion 63. The pinion 42e of the horizontal drive mechanism unit 40 meshes with the contact surfaces 62 of the first rack 60, and the pinion 52g of the vertical drive mechanism unit 50 meshes with the contact surfaces 62 of the second rack 60.

In the lens shifter, when moving the projection lens in the horizontal direction, the dial forming the driver 41 is rotated rightward or leftward to transmit torque to the pinion 42e with the gear train 42. The meshed pinion 42e and first rack 60 applies a linear driving force to the horizontal movable base member 20. This moves the projection lens in the horizontal direction with the horizontal movable base member 20.

To move the projection lens in the vertical direction, the dial forming the driver 51 is rotated rightward or leftward to transmit torque to the pinion 52g with the gear train 52. The meshed pinion 52g and second rack 60 applies a linear driving force to the vertical movable base member 30. This moves the projection lens in the horizontal direction with the vertical movable base member 30.

The lens shifter of the first embodiment has the advantages described below.

(1) The racks 60 have a large tooth width. Thus, even when the projector is dropped and a large impact is applied to the racks 60, the racks 60 have sufficient strength for resisting the impact.

(2) Each of the racks 60 does not use the tooth faces 61a and 61b entirely as force transmission surfaces and only uses the parts of the tooth faces 61a and 61b that extend in the tooth trace direction as the force transmission surfaces, namely, the contact surfaces 62. Accordingly, even when the rack 60 has a large tooth width to increase the strength, the sliding resistance at the tooth faces 61a and 61b is reduced.

(3) The contact surfaces 62 of the rack 60 are formed at the central parts of the tooth faces 61a and 61b. Further, the clearance portions 63 extend from opposite sides of each contact surface 62 in the tooth trace direction. The clearance portions 63 are formed to gradually enlarge the clearance region in the tooth trace direction from the end of the corresponding contact surface 62. Accordingly, the sliding resistance is minimized while preventing the strength of the rack 60 from decreasing.

(4) The racks 60 are used for the horizontal drive mechanism unit 40, which moves the horizontal movable base member 20 in the horizontal direction, and the vertical drive mechanism unit 50, which moves the vertical movable base member 30 in the vertical direction. That is, the racks 60, which have a strong strength and a small sliding frictional force (sliding resistance) are used in both the horizontal drive mechanism unit 40 and the vertical drive mechanism unit 50. This allows for the projection lens to be easily and smoothly moved in the vertical and horizontal directions.

(5) When the horizontal movable base member 20 moves in the horizontal direction, the second rack 60 moves along the pinion 52g while maintaining a state engaged with the pinion 52g of the vertical drive mechanism unit 50. In this case, the second rack 60, which reduces the slide resistance between the second rack 60 and the pinion 52g, smoothes the movement of the horizontal movable base member 20.

(6) With the projector of the lens shifter of the first embodiment, the sliding resistance of the rack 60 is reduced even when the projection lens is heavy. This smoothly shifts the projection lens.

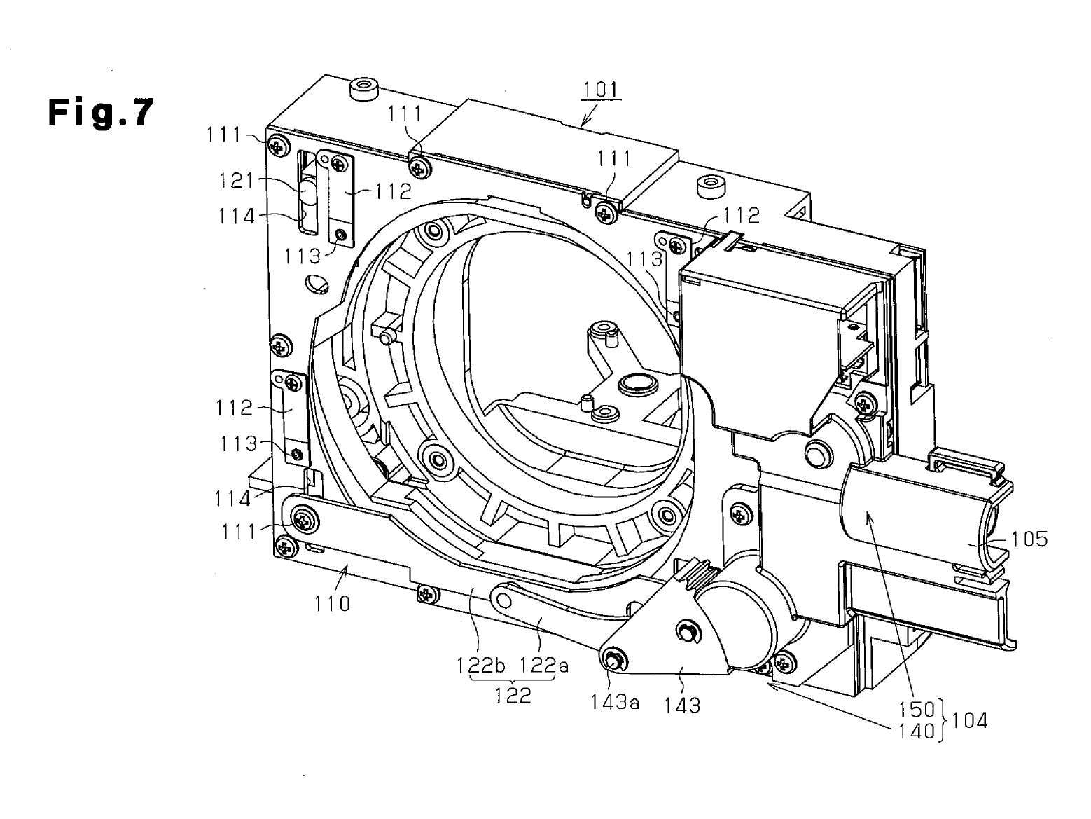

A lens shifter according to a second embodiment of the present invention will now be discussed with reference to FIGS. 7 to 9. In the description hereafter, the “horizontal direction” and the “vertical direction” respectively refer to the horizontal direction and vertical direction of the lens shifter when viewing the lens shifter from the front (from a position facing toward the projection lens).

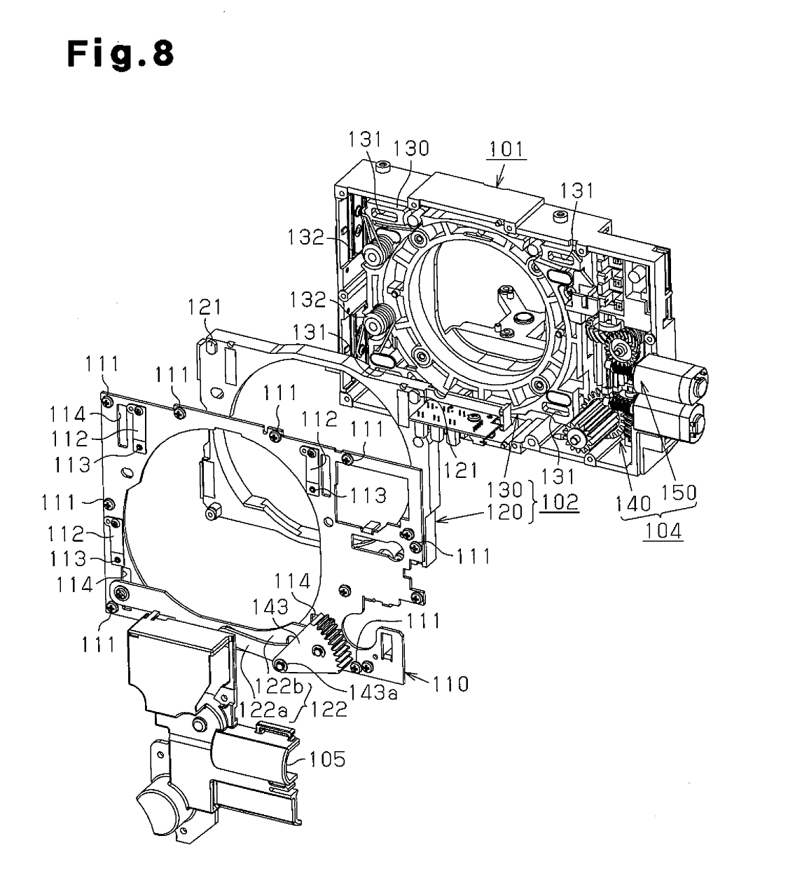

Like the first embodiment, the lens shifter is used in a three-chip type LCD projector. As shown in FIG. 8, the lens shifter includes a fixed base 110, which is fixed to a unit chassis 101, a movable base 102, which is movable relative to the fixed base 110 in the vertical direction and the horizontal direction, and a drive mechanism 104, which moves the movable base 102. A projection lens is attached to the movable base 102.

Referring to FIG. 7, the fixed base 110 is fastened by a plurality of screws 111 to the unit chassis 101, which is fixed to a frame formed by walls projecting from a main body chassis (not shown). As shown in FIG. 8, the movable base 102 includes a vertical movable base member 120, which is movable relative to the fixed base 110 in the vertical direction, and a horizontal movable base member 130, which is movable relative to the vertical movable base member 120 in the horizontal direction. The fastening of the fixed base 110 to the unit chassis 101 results in the vertical movable base member 120 and the horizontal movable base member 130 being accommodated in the unit chassis 101 in a state held between the fixed base 110 and the unit chassis 101 (refer to FIGS. 7 to 9).

The structure for fastening the fixed base 110 will now be described in detail. Spring members 112 are attached to the front surface of the fixed base 110 at four locations. Each spring member 112 has a lower end fixed to a resin pin 113, which extends through the fixed base 110. The resin pin 113 has a distal portion that presses the vertical movable base member 120 to the rear. This results in the elastic force of the spring member 112 acting rearward to elastically press the vertical movable base member 120 and the horizontal movable base member 130 against the unit chassis 101.

The vertical movable base member 120 is coupled to the fixed base 110 so as to be movable relative to the fixed base 110 in the vertical direction. The horizontal movable base member 130 is coupled to the vertical movable base member 120 so as to be movable in the horizontal direction. This structure will now be described in further detail.

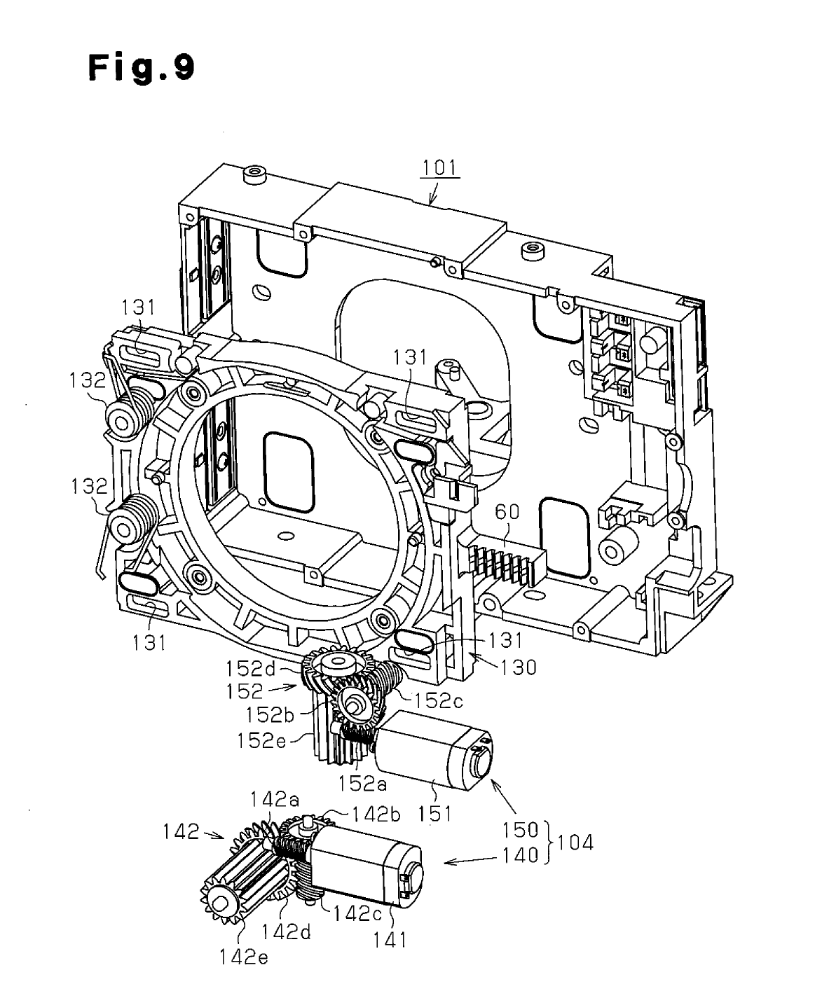

Cylindrical projections 121 project from four locations on the front surface of the vertical movable base member 120. Each of the projections 121 is fitted into an elongated vertical hole 114, which extends through the fixed base 110, and is movable within the elongated vertical hole 114. Further, the front surface of the fixed base 110 supports a sector gear 143 of a vertical drive mechanism unit 140. When the vertical drive mechanism unit 140 (refer to FIG. 9) pivots the sector gear 143, a support shaft 143a, which supports the sector gear 143, is rotated to move the vertical movable base member 120 in the vertical direction with a link mechanism 122.

Referring to FIG. 7, the link mechanism 122 includes a rod 122a, which is fixed to the support shaft 143a, and a lever 122b, which is pivotally connected to a distal end of the rod 122a and extended in the horizontal direction. The rod 122a is coupled to a central portion of the lever 122b. Further, the lever 122b has left and right ends connected to corresponding ones of the projections 121. Thus, when the sector gear 143 is pivoted, the rod 122a is pivoted. This vertically moves the lever 122b, which is pivotally coupled to the distal end of the rod 122a. Accordingly, the pivoting of the sector gear 143 moves the vertical movable base member 120 in the vertical direction with the rod 122a, which is fixed to the support shaft 143a, and the lever 122b.

The horizontal movable base member 130 includes a central opening through which the projection lens is inserted and fixed. The horizontal movable base member 130 is not fixed to the unit chassis 101 or the fixed base 110 and is movable relative to the vertical movable base member 120 in the horizontal direction. In this example, the vertical movable base member 120 has a rear surface with laterally elongated projections (not shown) projecting from four locations. The laterally elongated projections, which have substantially the same shape as the projections 121 described above, are fitted into horizontal elongated holes 131, which are formed in the horizontal movable base member 130. Accordingly, the horizontal movable base member 130 is movable relative to the vertical movable base member 120 in the horizontal direction within the movement range of the elongated projections in the horizontal elongated holes 131. Further, as shown in FIG. 9, a rack 60 extends toward the right from a right end of the horizontal movable base member 130. The rack 60 has the same teeth as those illustrated in the first embodiment. The horizontal drive mechanism unit 150 applies force to the rack 60 to produce movement in the horizontal direction. This moves the horizontal movable base member 130 in the horizontal direction. Two coil springs 132 are arranged on the left front side of the horizontal movable base member 130 at upper and lower locations. The coil springs 132 prevents the backlash of the rack 60 from lowering the movement accuracy. Further, the coil springs 132 each have an end supported by the frame of the unit chassis 101 so as to apply preload to the rack 60 in the rightward direction.

The drive mechanism 104 will now be discussed. The drive mechanism 104 includes the vertical drive mechanism unit 140, which moves the vertical movable base member 120 in the vertical direction, and a horizontal drive mechanism unit 150, which moves the horizontal movable base member 130 in the horizontal direction.

As shown in FIG. 9, the vertical drive mechanism unit 140 includes a driver 141, a gear train 142, and the sector gear 143 (refer to FIG. 8). The driver 141 generates force for driving the vertical movable base member 120. The gear train 142 transmits the force generated by the driver 141. The sector gear 143 receives force from the driver 141 via the gear train 142. As shown in FIG. 7, a cover 105 covers the driver 141 and the gear train 142.

In this example, the driver 141 uses a motor to shift the projection lens with electric power. The driver 141 and the gear train 142 are coupled to the unit chassis 101. The sector gear 143, which receives force from the driver 141 via the gear train 142, is coupled to the right side of the fixed base 110 to move the vertical movable base member 120 in the vertical direction with the link mechanism 122.

Referring to FIG. 9, the gear train 142 includes a worm 142a, a helical gear 142b, a worm 142c, and a helical gear 142d. The worm 142a is formed integrally with a drive shaft of the driver 141, namely, the motor. The helical gear 142b meshes with the worm 142a. The worm 142c is formed integrally with and extends downward from the helical gear 142b. The helical gear 142d meshes with the worm 142c. Further, a spur gear 142e is formed integrally with and extends frontward from the helical gear 142d. Torque from the spur gear 142e is transmitted to the sector gear 143, which is fixed to the support shaft 143a. When the sector gear 143 is pivoted, the link mechanism 122 moves the vertical movable base member 120 in the vertical direction.

The horizontal drive mechanism unit 150 includes a driver 151, a gear train 152, and the rack 60. The driver 151 generates force for driving the horizontal movable base member 130. The gear train 152 transmits the force generated by the driver 151. The teeth of the rack 60 have the same shape as those of the rack 60 in the first embodiment. As shown in FIG. 7, the cover 105 covers the driver 151 and the gear train 152 together with the driver 141 and the gear train 142.

Referring to FIG. 9, the gear train 152 is formed by components similar to those of the vertical drive mechanism unit 140. More specifically, the gear train 152 includes a worm 152a, a helical gear 152b, a worm 152c, and a helical gear 152d. The worm 152a is formed integrally with a drive shaft of the driver 151, namely, the motor. The helical gear 152b meshes with the worm 152a. The worm 152c is formed integrally with and extends rearward from the helical gear 152b. The helical gear 152d meshes with the worm 152c. Further, a spur gear 152e is formed integrally with and extends downward from the helical gear 152d. Torque from the spur gear 152e is transmitted to the rack 60, which is fixed to the horizontal movable base member 130. Movement of the rack 60 in the horizontal direction horizontally moves the horizontal movable base member 130, which is formed integrally with the rack 60, in the horizontal direction.

In the second embodiment, when the vertical movable base member 120 moves in the vertical direction, the horizontal movable base member 130 moves integrally with the vertical movable base member 120 in the vertical direction. Accordingly, to keep the spur gear 152e and rack 60 meshed with each other during the vertical movement, the spur gear 152e has a length corresponding to the amount of vertical movement. That is, when the vertical movable base member 120 moves vertically, the spur gear 152e and the rack 60 move relative to each other in the vertical direction.

The rack 60 reduces the sliding resistance produced with the spur gear 152e and smoothes the movement of the projection lens. The rack 60 of the second embodiment has a structure similar to that of the first embodiment described in FIGS. 5 and 6. More specifically, the rack 60 has teeth 61, with tooth faces 61a and 61b extending from opposite sides of each tooth 61. Each of the tooth faces 61a and 61b includes a contact surface 62 and clearance portions 63. The contact surface 62 is formed by a central part of each of the tooth faces 61a and 61b in the tooth trace direction and serves as a force transmission surface. The clearance portions 63 extend from opposite sides of the contact surface 62 along the tooth trace direction. The spur gear 152e in the gear train 152 of the horizontal drive mechanism unit 150 meshes with the contact surfaces 62 of the rack 60.

In the lens shifter, when moving the projection lens in the vertical direction, the driver 141, or motor, produces leftward or rightward rotation to transmit torque to the sector gear 143 via the gear train 142. Rotation of the sector gear 143 drives the link mechanism 122 and vertically moves the vertical movable base member 120. The horizontal movable base member 130, which is coupled to the vertical movable base member 120 so as to be movable in the horizontal direction, moves vertically together with the vertical movable base member 120. In this manner, the projection lens, which is attached to the horizontal movable base member 130, may be moved in the vertical direction.

To move the projection lens in the horizontal direction, the driver 141, or motor, produces leftward or rightward rotation to transmit torque to the spur gear 152e via the gear train 142. The meshed spur gear 152e and rack 60 applies a linear driving force to the horizontal movable base member 130. This moves the projection lens in the horizontal direction together with the vertical movable base member 30.

In addition to advantages (1) to (3) and (6) of the first embodiment, the lens shifter of the second embodiment has the advantages described below.

(7) The rack 60, which is formed in the same manner as that of the first embodiment, is arranged on the horizontal drive mechanism unit 150, which moves the horizontal movable base member 130 in the horizontal direction. That is, the rack 60 has a large tooth width, and the contact surface 62 is formed on only the central part of each tooth face in the tooth trace direction. This reduces sliding frictional force produced at the rack 60 to thereby smooth the movement of the projection lens.

(8) When the vertical movable base member 120 moves in the vertical direction, the rack 60 moves along the spur gear 152e while maintaining a state engaged with the spur gear 152e of the horizontal drive mechanism unit 150. Accordingly, sliding frictional force is reduced between the rack 60 and the spur gear 152e, and the movement of the vertical movable base member 120 is smoother.

It should be apparent to those skilled in the art that the present invention may be embodied in many other specific forms without departing from the spirit or scope of the invention. Particularly, it should be understood that the present invention may be embodied in the following forms.

In the second embodiment, the vertical drive mechanism unit 140 may transmit vertical driving force with a rack in the same manner as in the first embodiment.

In the second embodiment, the drivers 141 and 151 are formed by motors. However, the drivers 141 and 151 may be manually driven like the first embodiment. Although the specific structure is not described here, the drivers 141 and 151 may be a type that is driven both manually and electrically.

In the first and second embodiments, the clearance portions 63 are each formed linearly so that the clearance dimensions are set to become gradually larger in the tooth trace direction from an end of the corresponding contact surface 62. However, the clearance portions 63 may each be curved to set such clearance dimensions. In this case, it is preferred that the clearance portions 63 be curved so that the tooth thickness at the clearance portions 63 does not suddenly decrease from the ends of the contact surface 62. As a result, less stress concentrates at the two ends of the contact surface than when the clearance portions 63 are formed linearly.

In the first embodiment, the rack 60 of the horizontal drive mechanism 40 may be replaced by another drive force transmission mechanism (e.g., the link mechanism of the second embodiment). In contrast, the rack 60 of the vertical drive mechanism unit 50 would require a mechanism enabling horizontal movement between the pinion 52g and the rack 60 when moving the horizontal movable base member 20. Thus, the rack 60 of the vertical drive mechanism unit 50 cannot be easily replaced by another mechanism.

The present examples and embodiments are to be considered as illustrative and not restrictive, and the invention is not to be limited to the details given herein, but may be modified within the scope and equivalence of the appended claims.

What is claimed is:

1. A lens shifter for a projection lens, the lens shifter comprising:
a fixed base;
a movable base that is movable relative to the fixed member, in which the projection lens is mounted to the movable base; and
a drive mechanism that applies force to the movable base, the drive mechanism including:
a driver that generates force;
a gear train that transmits the force generated by the driver; and
a rack that converts the force transmitted from the gear train into driving force for the movable base, the rack including;
a tooth face extending along a tooth trace direction; and
a contact surface that is formed only on part of the tooth face and receives the force transmitted from the gear train.

2. The lens shifter according to claim 1, wherein the contact surface is formed at a central part of the tooth face in the tooth trace direction, the rack further comprising:
clearance portions extending from opposite sides of the contact surface in the tooth trace direction, wherein the clearance portions each provide a clearance dimension that gradually increases along the tooth trace direction from the contact surface.

3. The lens shifter according to claim 2, wherein the clearance portions are formed linearly from the contact surface.

4. The lens shifter according to claim 2, wherein the clearance portions are formed to be curved from the contact surface.

5. The lens shifter according to claim 1, wherein the movable base includes:
a horizontal movable base member that is directly or indirectly movable relative to the fixed base in a horizontal direction; and
a vertical movable base member that is directly or indirectly movable relative to the fixed base in a vertical direction;
the drive mechanism includes:
a horizontal drive mechanism unit that moves the horizontal movable base member in the horizontal direction; and
a vertical drive mechanism unit that moves the vertical movable base member in the vertical direction; and
the rack is arranged on at least either one of the horizontal drive mechanism unit and the vertical drive mechanism unit, the rack being formed integrally with the horizontal movable base member when the rack is arranged on the horizontal drive mechanism unit, and the rack being formed integrally with the vertical movable base member when the rack is arranged on the vertical drive mechanism unit.

6. The lens shifter according to claim 1, wherein the movable base includes:
a horizontal movable base member that is movable relative to the fixed base in a horizontal direction; and
a vertical movable base member that moves integrally with the horizontal movable base member in the horizontal direction and is movable relative to the horizontal movable base member in a vertical direction; the drive mechanism includes:
a horizontal drive mechanism unit that moves the horizontal movable base member in the horizontal direction; and
a vertical drive mechanism unit that moves the vertical movable base member in the vertical direction; and
the rack is arranged on each of the horizontal drive mechanism unit and the vertical drive mechanism unit, the rack arranged on the horizontal drive mechanism unit being formed integrally with the horizontal movable base member, and the rack arranged on the vertical drive mechanism unit being formed integrally with the vertical movable base member.

7. The lens shifter according to claim 1, wherein the movable base includes:
a vertical movable base member that is movable relative to the fixed base in a vertical direction; and
a horizontal movable base member that moves integrally with the vertical movable base member in the vertical direction and is movable relative to the vertical movable base member in a horizontal direction; the drive mechanism includes:
a horizontal drive mechanism unit that moves the horizontal movable base member in the horizontal direction; and
a vertical drive mechanism unit that moves the vertical movable base member in the vertical direction; and
the rack is arranged on the horizontal drive mechanism unit, with the rack being formed integrally with the horizontal movable base member.

8. A projector including a projection lens, the projector comprising:
a lens shifter comprising:
a fixed base;
a movable base that is movable relative to the fixed member, in which the projection lens is mounted to the movable base; and
a drive mechanism that applies force to the movable base, the drive mechanism including:
a driver that generates force;
a gear train that transmits the force generated by the driver; and
a rack that converts the force transmitted from the gear train into driving force for the movable base, the rack including;
a tooth face extending along a tooth trace direction; and
a contact surface that is formed only on part of the tooth face and receives the force transmitted from the gear train.
